(19) United States
(12) Patent Application Publication
(10) Pub. No.: US 2019/0356169 A1
(43) Pub. Date: Nov. 21, 2019

(54) WIRELESS POWER TRANSMISSION DEVICE AND POWER TRANSFER SYSTEM

(71) Applicant: TOYOTA JIDOSHA KABUSHIKI KAISHA, Toyota-shi (JP)

(72) Inventor: Takahiro MISAWA, Okazaki-shi (JP)

(73) Assignee: TOYOTA JIDOSHA KABUSHIKI KAISHA, Toyota-shi (JP)

(21) Appl. No.: 16/400,220

(22) Filed: May 1, 2019

(30) Foreign Application Priority Data
May 18, 2018 (JP) 2018-095961

(51) Int. Cl. H02J 50/12

(52) U.S. Cl. CPC H02J 50/12; H02M 7/5387

(57) ABSTRACT

In power control and frequency control carried out for a prescribed first period, when magnitude of output power does not converge in power control and a frequency of output power does not converge in frequency control, a power supply ECU stops frequency control and carries out only power control for a prescribed second period. When magnitude of output power has converged after lapse of the second period, the power supply ECU determines that a condition for frequency control is inappropriate. When magnitude of output power does not converge after lapse of the second period, the power supply ECU determines that a condition for power control is inappropriate.

This nonprovisional application is based on Japanese Patent Application No. 2018-095961 filed with the Japan Patent Office on May 18, 2018, the entire contents of which are hereby incorporated by reference.

### BACKGROUND

### Field

The present disclosure relates to a wireless power transmission device and a power transfer system and particularly to a technique for controlling an inverter in a wireless power transmission device configured to wirelessly transmit power to a power reception device.

### Description of the Background Art

A power transfer system configured to wirelessly transfer power from a power transmission device to a power reception device has been known (see, for example, Japanese Patent Laying Open No. 2013-154815, Japanese Patent Laying Open No. 2013-146154, Japanese Patent Laying Open No. 2013-146148, Japanese Patent Laying Open No. 2013-110822, Japanese Patent Laying Open No. 2013-126327, and Japanese Patent Laying Open No. 2017-5865). Japanese Patent Laying Open No. 2017-5865 discloses controlling magnitude of transmission power to target power by regulating a duty of a voltage output from an inverter provided in a power transmission device and controlling a turn-on current of the inverter by regulating a drive frequency for the inverter.

### SUMMARY

A wireless power transmission device described in Japanese Patent Laying Open No. 2017-5865 wirelessly transmits power to a power reception device while it regulates both of a duty of a voltage output from the inverter and a drive frequency for the inverter. In such a power transmission device, output power (and hence transmission power) from the inverter tends to be unstable. For example, when at least one of magnitude and a frequency of output power from the inverter does not converge, transmission power becomes unstable. When transmission power is unstable, it may excessively become high. Therefore, when a state that transmission power is unstable continues in the power transmission device as above, it is determined that an abnormal condition has occurred in the power transmission device in diagnostic determination and power transmission is suspended.

If a factor which makes transmission power unstable can be identified, however, transmission power can be stabilized by removing the factor so that power transmission can be continued. For example, when transmission power has become unstable due to a control condition, transmission power can be stabilized by changing the control condition.

The present disclosure was made to solve such a problem and an object thereof is to identify a factor for unstable transmission power when transmission power becomes unstable while both of power control for converging magnitude of electric power and frequency control for converging a frequency of electric power are being carried out in a wireless power transmission device.

A wireless power transmission device in the present disclosure includes a power transmitter configured to wirelessly transmit power to a power reception device, an inverter configured to generate power at a prescribed frequency and output the generated power to the power transmitter, a loss detector configured to detect power loss, and a controller configured to control power output from the inverter (which is also referred to as “output power” below). The controller is configured to carry out power control for converging magnitude of the output power to target power and frequency control for converging a frequency of the output power to an optimal frequency at which power loss detected by the loss detector is minimized.

The controller is configured to stop the frequency control and perform only the power control for a prescribed second period when magnitude of the output power does not converge and a frequency of the output power does not converge in the power control and the frequency control carried out for a prescribed first period, determine that a condition for the frequency control is inappropriate when magnitude of the output power has converged after lapse of the second period, and determine that a condition for the power control is inappropriate when magnitude of the output power does not converge after lapse of the second period.

A power transfer system according to the present disclosure includes a power transmission device and a power reception device configured to wirelessly receive power from the power transmission device. The wireless power transmission device according to the present disclosure including the features above is provided as the power transmission device.

When transmission power is unstable while power control and frequency control are being carried out, a condition in at least one of power control and frequency control is highly likely to be inappropriate. When neither of magnitude and a frequency of output power converges, however, one cannot know in which control a condition is inappropriate. In the wireless power transmission device and the power transfer system above, a state that only power control is being carried out is created by stopping frequency control. Then, when magnitude of output power has converged, a condition for frequency control is determined as inappropriate, and when magnitude of output power does not converge, a condition for power control is determined as inappropriate. As a result of this determination, a factor for unstable transmission power (that is, in which control a condition is inappropriate) is identified.

When a control condition in one of power control and frequency control can be identified as inappropriate in the determination above, whether or not a control condition in the other is appropriate can readily be determined. For example, when transmission power is stabilized by carrying out again power control and frequency control after changing a control condition determined as inappropriate to an appropriate condition, a control condition in the other is appropriate, and when transmission power is still unstable, a control condition in the other is inappropriate.

The controller may be configured, in the power control and the frequency control carried out for the first period, to determine that the condition for the frequency control is inappropriate when magnitude of the output power has converged in the power control and the frequency of the output power does not converge in the frequency control and to determine that the condition for the power control is inappropriate when the frequency of the output power has converged in the frequency control and magnitude of the output power does not converge in the power control. According to such a configuration, when only one of magnitude and a frequency of output power does not converge as well, a factor for unstable transmission power can be identified.

When the condition for the power control is determined as inappropriate, the controller may be configured to decrease a control gain in the power control. When transmission power becomes unstable due to an inappropriate condition for power control, it is highly likely that sensitivity of variation in power to manipulation in the power control is excessively high. Therefore, by decreasing a control gain in power control, it is highly likely that an appropriate condition is set (or a condition is closer to an appropriate condition).

The controller may include a first generator, an extractor, a multiplier, a calculator, and a second generator which will be described below. The first generator generates an oscillation signal indicating a waveform of a first frequency manipulation amount for oscillating a frequency of the output power. The extractor extracts a high-frequency component from a waveform of power loss cyclically detected by the loss detector described previously. The multiplier obtains a multiplication value resulting from multiplication of a loss variation amount by the first frequency manipulation amount, the loss variation amount being represented by the high-frequency component, the first frequency manipulation amount being represented by the oscillation signal. The calculator calculates a second frequency manipulation amount for bringing the multiplication value closer to 0. The second generator generates a drive signal for the inverter by using a prescribed reference frequency, the second frequency manipulation amount, and the oscillation signal.

The configuration above is particularly preferred as a configuration for the controller to carry out frequency control from a point of view of accuracy and stability in control as well as costs.

When the condition for the frequency control is determined as inappropriate as described previously, the controller may be configured to extend an oscillation cycle of the oscillation signal. When transmission power becomes unstable due to an inappropriate condition for frequency control, it is highly likely that sensitivity of variation in electric power to manipulation in the frequency control is excessively high. Therefore, by extending the oscillation cycle of the oscillation signal which oscillates a frequency of output power, it is highly likely that an appropriate condition is set (or a condition is closer to an appropriate condition).

In the wireless power transmission device, the power transmitter may include a resonant circuit including a power transmission coil. The inverter may include a switching element driven by a drive signal from the controller and a freewheel diode connected in parallel to the switching element. The loss detector may be configured to detect the power loss by using a current flowing through the power transmission coil, a current flowing through the inverter, and a turn-on current representing an output current from the inverter at the time of rise of an output voltage from the inverter. With such a loss detector, power loss in the wireless power transmission device can highly accurately and appropriately be detected.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram of an overall configuration of a power transfer system according to an embodiment of the present disclosure.

FIG. 2 is a diagram showing one example of a circuit configuration of a power transmitter and a power receiver of the power transfer system shown in FIG. 1.

FIG. 3 is a diagram showing one example of a circuit configuration of an inverter shown in FIG. 1.

FIG. 4 is a diagram showing a waveform of switching of the inverter shown in FIG. 1, a waveform of an output voltage, and a waveform of an output current.

FIG. 5 is a diagram showing one example of relation between power loss in a power transmission device and an output frequency from the inverter in a situation that magnitude of output power from the inverter shown in FIG. 1 is constant.

FIG. 6 is a control block diagram of power control and frequency control in a wireless power transmission device according to the embodiment of the present disclosure.

FIG. 7 is a diagram showing one example of an oscillation signal generated by an oscillation signal generator shown in FIG. 6.

FIG. 8 is a flowchart for illustrating diagnostic determination made by a controller of the wireless power transmission device according to the embodiment of the present disclosure.

FIG. 9 is a flowchart for illustrating processing based on a result of diagnostic determination in FIG. 8.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

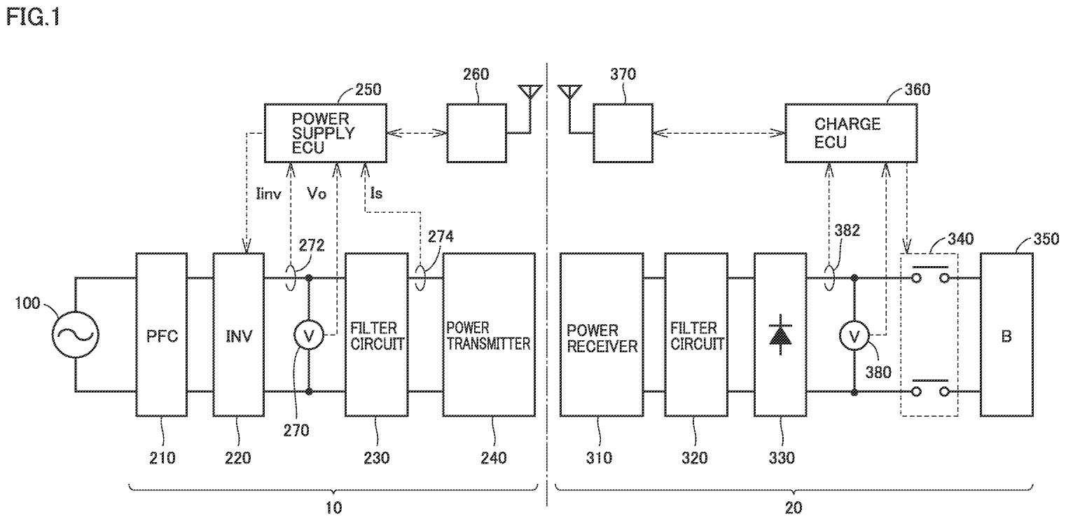

FIG. 1 is a diagram of an overall configuration of a power transfer system according to an embodiment of the present disclosure. Referring to FIG. 1, the power transfer system includes a power transmission device 10 and a power reception device 20. Power reception device 20 is mounted, for example, on a vehicle which can travel with electric power supplied from power transmission device 10 and stored therein. Though a resonance scheme is adopted as a wireless power transfer scheme in this embodiment, another scheme (electromagnetic induction scheme and the like) may be adopted.

Power transmission device 10 includes a power factor correction (PFC) circuit 210, an inverter 220, a filter circuit 230, and a power transmitter 240. Power transmission device 10 further includes a power supply electronic control unit (ECU) 250, a communication device 260, a voltage sensor 270, and current sensors 272 and 274.

PFC circuit 210 can rectify and boost alternating-current (AC) power received from an AC power supply 100 (for example, a system power supply) and supply resultant power to inverter 220, and can correct a power factor by making an input current more sinusoidal. Various known PFC circuits can be adopted for PFC circuit 210. Instead of PFC circuit 210, a rectifier without a power factor correction function may be adopted.

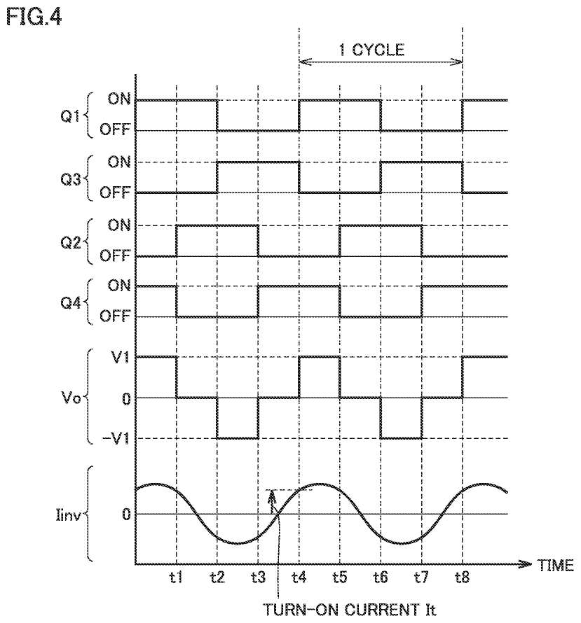

Inverter 220 is configured to convert input electric power (more specifically, direct-current (DC) power) from PFC circuit 210 into AC power at a prescribed frequency and output AC power to power transmitter 240. Output power from inverter 220 is supplied to power transmitter 240 through filter circuit 230. In the embodiment, inverter 220 is a voltage source inverter (for example, a single-phase full bridge circuit shown in FIG. 3 which will be described later). Inverter 220 is configured to vary a frequency of output power (which is also simply referred to as an “output frequency” below) within a prescribed frequency range (which is also referred to as an “output frequency range” below). Each switching element implementing inverter 220 is controlled in accordance with a drive signal from power supply ECU 250. The output frequency from inverter 220 is varied in accordance with a switching frequency indicated by the drive signal (which is also referred to as a “drive frequency” below). The drive frequency for inverter 220 matches with the output frequency from inverter 220 and hence with a power transmission frequency (a frequency of transmission power). Though details will be described later, a duty of an output voltage from inverter 220 is controlled also in accordance with a drive signal from power supply ECU 250. Then, magnitude of output power from inverter 220 is varied in accordance with the duty of the output voltage from inverter 220. The duty of the output voltage from inverter 220 is defined as a ratio of a positive (or a negative) voltage output time period to a cycle of a waveform of the output voltage (a rectangular wave) (see FIG. 4 which will be described later).

Voltage sensor 270 detects an output voltage Vo from inverter 220 and outputs a detected value thereof to power supply ECU 250. Current sensor 272 detects an output current Iinv from inverter 220 and outputs a detected value thereof to power supply ECU 250. Power supply ECU 250 can detect output power from inverter 220 based on detection values from voltage sensor 270 and current sensor 272.

Filter circuit 230 suppresses harmonic noise generated from inverter 220. Filter circuit 230 is implemented, for example, by an LC filter including an inductor and a capacitor.

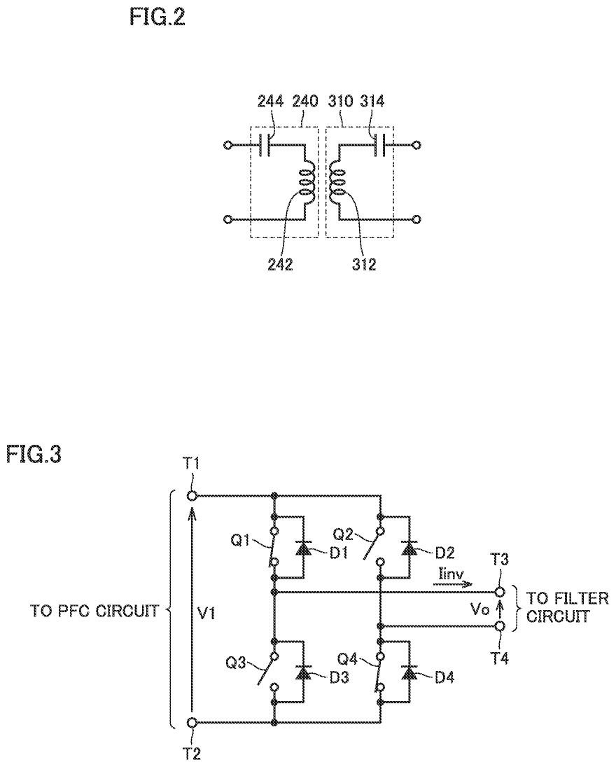

Power transmitter 240 receives output power (AC power) from inverter 220 through filter circuit 230 and wirelessly transmits power to a power receiver 310 of power reception device 20 through magnetic field generated around power transmitter 240. Power transmitter 240 includes a resonant circuit (for example, a series resonant circuit shown in FIG. 2 which will be described later). Current sensor 274 detects a current Is which flows to power transmitter 240 and outputs a detected value thereof to power supply ECU 250.

Power supply ECU 250 includes a central processing unit (CPU) as a processor, a storage device, and an input and output buffer (none of which is shown). The storage device includes a random access memory (RAM) as a working memory and a storage for saving (for example, a read only memory (ROM) and a rewritable non-volatile memory). Power supply ECU 250 has a timer function. The timer function can be performed by either of hardware and software. Power supply ECU 250 carries out various types of control by execution by the CPU of a program stored in the storage device. Various types of control can also be processed by dedicated hardware (electronic circuits) without being limited to processing by software. Power supply ECU 250 according to the embodiment corresponds to one example of the “controller” according to the present disclosure.

Communication device 260 is configured to wirelessly communicate with a communication device 370 of power reception device 20. Communication device 260 sends information to power reception device 20 or receives information (for example, target power which will be described later) from power reception device 20.

Power reception device 20 includes power receiver 310, a filter circuit 320, a rectification circuit 330, a relay circuit 340, and a power storage device 350. Power reception device 20 further includes a charge ECU 360, communication device 370, a voltage sensor 380, and a current sensor 382.

Power receiver 310 includes a resonant circuit (for example, a series resonant circuit shown in FIG. 2 which will be described later) for wirelessly receiving power from power transmitter 240. Power receiver 310 outputs received power to rectification circuit 330 through filter circuit 320.

Filter circuit 320 is configured to suppress harmonic noise generated during reception of power by power receiver 310. Filter circuit 320 is implemented, for example, by an LC filter including an inductor and a capacitor. Rectification circuit 330 rectifies AC power received by power receiver 310 and outputs rectified AC power to power storage device 350. Rectification circuit 330 includes a smoothing capacitor together with a rectifier.

Relay circuit 340 is provided between rectification circuit 330 and power storage device 350. Relay circuit 340 is subjected to on/off control by charge ECU 360 and it is turned on (set to a conducting state) while power storage device 350 is charged by power transmission device 10.

Power storage device 350 is a rechargeable DC power supply, and implemented, for example, by a secondary battery such as a lithium ion battery or a nickel metal hydride battery. Power storage device 350 stores power output from rectification circuit 330. Power stored in power storage device 350 is supplied, for example, to a not-shown load driving device. An electric double layer capacitor can also be adopted as power storage device 350.

Voltage sensor 380 detects an output voltage (a reception power voltage) from rectification circuit 330 and outputs a detected value thereof to charge ECU 360. Current sensor 382 detects an output current (a reception power current) from rectification circuit 330 and outputs a detected value thereof to charge ECU 360. Power received by power receiver 310 (that is, charging power for power storage device 350) can be detected based on detection values from voltage sensor 380 and current sensor 382.

Charge ECU 360 includes a CPU as a processor, a storage device, and an input and output buffer (none of which is shown), and receives signals from various sensors and controls various types of equipment in power reception device 20. Various types of control can also be processed by dedicated hardware (electronic circuits) without being limited to processing by software.

Communication device 370 is configured to wirelessly communicate. Wireless communication between communication device 370 of power reception device 20 and communication device 260 of power transmission device 10 allows exchange of information between power supply ECU 250 and charge ECU 360.

Each of power transmitter 240 and power receiver 310 shown in FIG. 1 includes a resonant circuit and is designed to resonate at a frequency of transmission power. FIG. 2 is a diagram showing one example of a circuit configuration of power transmitter 240 and power receiver 310.

Referring to FIG. 2, power transmitter 240 includes a coil 242 (a power transmission coil) and a capacitor 244 connected in series (that is, a series resonant LC circuit). A Q factor representing resonance intensity of the resonant circuit in power transmitter 240 is preferably not smaller than 100.

Power receiver 310 includes a coil 312 (a power reception coil) and a capacitor 314 connected in series (that is, a series resonant LC circuit). A Q factor of the resonant circuit in power receiver 310 is also preferably not smaller than 100.

FIG. 3 is a diagram showing one example of a circuit configuration of inverter 220 shown in FIG. 1. Referring to FIG. 3, inverter 220 includes a plurality of switching elements Q1 to Q4 and a plurality of freewheel diodes D1 to D4. Switching elements Q1 to Q4 are each implemented by a power semiconductor switching element such as an IGBT, a bipolar transistor, a MOSFET, or a GTO. Freewheel diodes D1 to D4 are connected in parallel (more specifically, anti-parallel) to switching elements Q1 to Q4, respectively. PFC circuit 210 (FIG. 1) is connected to terminals T1 and T2 on a DC side and filter circuit 230 (FIG. 1) is connected to terminals T3 and T4 on an AC side.

A DC voltage output from PFC circuit 210 is applied across terminals T1 and T2. In FIG. 3, V1 represents magnitude of this DC voltage. Switching elements Q1 to Q4 are driven by a drive signal from power supply ECU 250. With a switching operation by switching elements Q1 to Q4, output voltage Vo is applied across terminals T3 and T4 so that output current Iinv flows (a direction shown with an arrow in FIG. 3 being defined as a positive direction). FIG. 3 shows a state that switching elements Q1 and Q4 are turned on and switching elements Q2 and Q3 are turned off by way of example, and output voltage Vo at this time is at substantially V1 (a positive value).

FIG. 4 is a diagram showing a waveform of switching of inverter 220 and a waveform of each of output voltage Vo and output current Iinv. An operation by inverter 220 will be described below with reference to FIG. 4 together with FIG. 3, by way of example of one cycle from time t4 to t8.

When switching element Q1 is switched from OFF to ON and switching element Q3 is switched from ON to OFF at time t4 while switching elements Q2 and Q4 are OFF and ON, respectively, each switching element is set to a state shown in FIG. 3 and output voltage Vo from inverter 220 rises from 0 to V1 (a positive value).

Thereafter, with variation in state of each switching element as shown below at time t5 to t8, output voltage Vo is also varied. When switching element Q2 is switched from OFF to ON and switching element Q4 is switched from ON to OFF at time t5, output voltage Vo attains to 0. When switching element Q1 is switched from ON to OFF and switching element Q3 is switched from OFF to ON at time t6, output voltage Vo attains to −V1 (a negative value). When switching element Q2 is switched from ON to OFF and switching element Q4 is switched from OFF to ON at time t7, output voltage Vo attains again to 0.

At time t8 which is one cycle after time t4, switching element Q1 is switched from OFF to ON and switching element Q3 is switched from ON to OFF. Each switching element is thus set to a state the same as the state at time t4 and output voltage Vo rises from 0 to V1 (positive value).

FIG. 4 shows an example where a duty of output voltage Vo is set to 0.25. A proportion of a positive voltage output time period (t4 to t5) in one cycle (t4 to t8) is ¼ (=0.25). A proportion of a negative voltage output time period (t6 to t7) in one cycle (t4 to t8) is also ¼ (=0.25). As the duty of output voltage Vo is higher, a time period during which output voltage Vo is positive (V1) and negative (−V1) in one cycle is longer. Therefore, as the duty of output voltage Vo is higher, output power from inverter 220 is higher.

By varying switching timing of switching elements Q1 and Q3 and switching timing of switching elements Q2 and Q4, a duty of output voltage Vo can be varied. For example, by advancing switching timing of switching elements Q2 and Q4 relative to the state shown in FIG. 4, a duty of output voltage Vo can be lower than 0.25 (a minimum value being 0). Alternatively, by retarding switching timing of switching elements Q2 and Q4 relative to the state shown in FIG. 4, a duty of output voltage Vo can be higher than 0.25 (a maximum value being 0.5).

By regulating a duty of output voltage Vo, magnitude of output power from inverter 220 and hence transmission power (electric power supplied to power transmitter 240) can be varied. Qualitatively, output power from inverter 220 can be increased by increasing a duty and can be decreased by decreasing a duty. Therefore, power supply ECU 250 can bring magnitude of output power from inverter 220 closer to target power by regulating a duty of output voltage Vo.

An instantaneous value of output current Iinv at the time of rise of output voltage Vo (time t4, t8) corresponds to a turn-on current It. Turn-on current It represents an output current from inverter 220 at the time of rise of an output voltage from inverter 220. A value of turn-on current It is varied in accordance with a voltage (V1) provided from PFC circuit 210 to inverter 220 and a drive frequency (a switching frequency) for inverter 220.

Conduction loss and switching loss define main power loss in power transmission device 10. Switching loss refers to power loss caused at the time of a switching operation (turn-on and turn-off). In power transmission device 10, power loss due to turn-on current It generated at the time of turn-on of a switching element which implements inverter 220 represents dominant switching loss. Conduction loss refers to power loss caused by conduction. In power transmission device 10, power loss due to heat generation resulting from conduction of coil 242 (power transmission coil) and inverter 220 represents dominant conduction loss.

For example, FIG. 4 shows an example in which positive turn-on current It flows. When positive turn-on current It flows, a current (that is, a recovery current) flows through freewheel diode D3 (see FIG. 3) connected in parallel to switching element Q3. When a recovery current flows through freewheel diode D3, heat generation in freewheel diode D3 increases and power loss in inverter 220 increases. When turn-on current It is not higher than 0, no recovery current flows through freewheel diode D3 and power loss in inverter 220 is suppressed. Since turn-on current It is varied in accordance with a drive frequency for inverter 220, power supply ECU 250 can control turn-on current It by regulating a drive frequency for inverter 220.

Though details will be described later, power supply ECU 250 detects power loss in power transmission device 10 in the embodiment. More specifically, the sum of power loss due to turn-on current It, power loss due to a current which flows through coil 242, and power loss due to a current which flows through inverter 220 is detected as power loss in power transmission device 10.

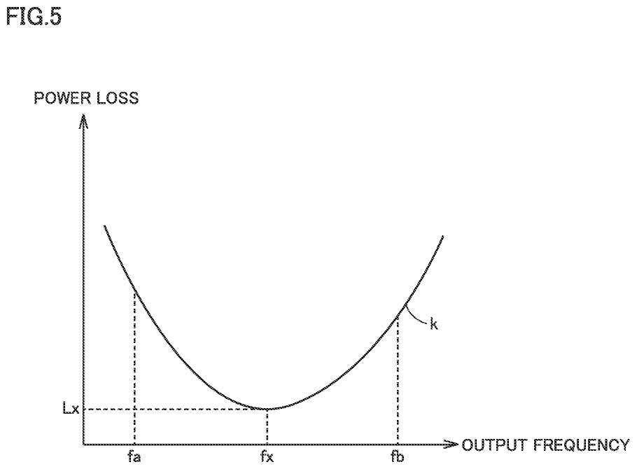

Power loss in power transmission device 10 is varied by a drive frequency for inverter 220 and hence by an output frequency from inverter 220. FIG. 5 is a diagram showing one example of relation between power loss in power transmission device 10 and an output frequency from inverter 220 in a situation that magnitude of output power from inverter 220 is constant. In FIG. 5, fa and fb represent lower limit and upper limit frequencies within an output frequency range of inverter 220, respectively. Namely, fa to fb corresponds to the output frequency range of inverter 220.

Referring to FIG. 5, relation between an output frequency from inverter 220 (abscissa) and power loss in power transmission device 10 (ordinate) is shown with a curve k which projects downward. Power loss in power transmission device 10 is minimized (a relative minimum value Lx) at the time when the output frequency from inverter 220 attains to an optimal frequency fx (which is also simply referred to as “fx” below).

At an extreme value (fx) of curve k, an inclination of curve k is 0. In a region on a low-frequency side lower than fx, the inclination of curve k is negative, and as an output frequency from inverter 220 is closer to fx, the inclination of curve k is closer to 0. In a region on a high-frequency side higher than fx, the inclination of curve k is positive, and as the output frequency from inverter 220 is closer to fx, the inclination of curve k is closer to 0. The inclination of curve k thus represents positional relation between the output frequency from inverter 220 and fx.

In the embodiment, power supply ECU 250 carries out power control for controlling magnitude of output power from inverter 220 and frequency control for controlling an output frequency from inverter 220. In power control, magnitude of output power from inverter 220 is converged to target power by regulating a duty of an output voltage from inverter 220. Magnitude of AC power can be expressed, for example, by an effective value. In frequency control, an output frequency from inverter 220 is converged to an optimal frequency by searching for an optimal frequency while the output frequency from inverter 220 is varied.

As power transmission device 10 simultaneously carries out power control and frequency control during power transfer from power transmission device 10 to power reception device 20, an optimal frequency (an extreme value of a frequency at which power loss is minimized) can be searched for (which is also referred to as “extreme value search” below) by varying the output frequency within the output frequency range of inverter 220 while magnitude of output power from inverter 220 is maintained at a prescribed value (target power). Power transfer at an optimal frequency at which power loss is low improves energy efficiency (a ratio of recoverable energy to input energy) in the entire power transfer system.

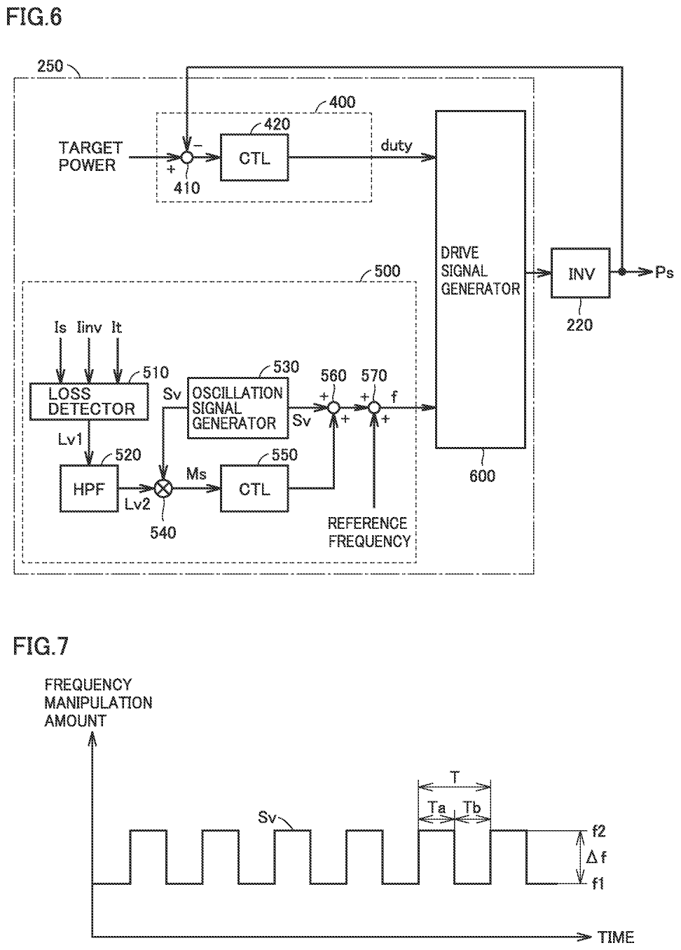

FIG. 6 is a control block diagram of power control and frequency control in power supply ECU 250. Referring to FIG. 6, power supply ECU 250 includes a power controller 400 which carries out power control, a frequency controller 500 which carries out frequency control, and a drive signal generator 600 which generates a drive signal for inverter 220.

Power controller 400 includes a subtractor 410 and a control circuit 420. Subtractor 410 subtracts a detected value of output power (which is referred to as “output power Ps” below) from inverter 220 from target power representing a target value of transmission power and outputs a calculated value (that is, a difference between target power and output power Ps) to control circuit 420. Output power Ps is calculated, for example, based on detection values from voltage sensor 270 and current sensor 272 shown in FIG. 1. Target power is generated, for example, in power reception device 20 based on a condition of power reception by power reception device 20 and transmitted from power reception device 20 to power transmission device 10.

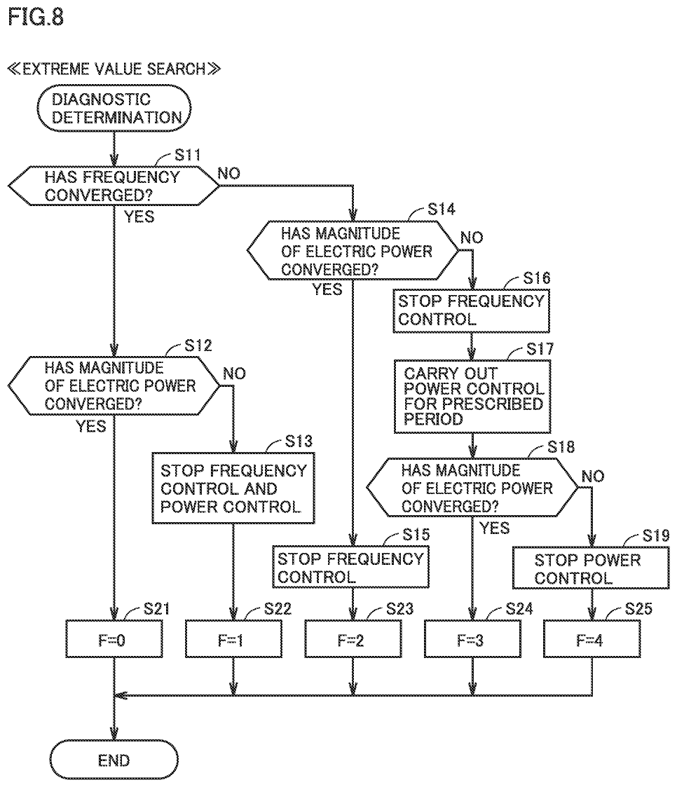

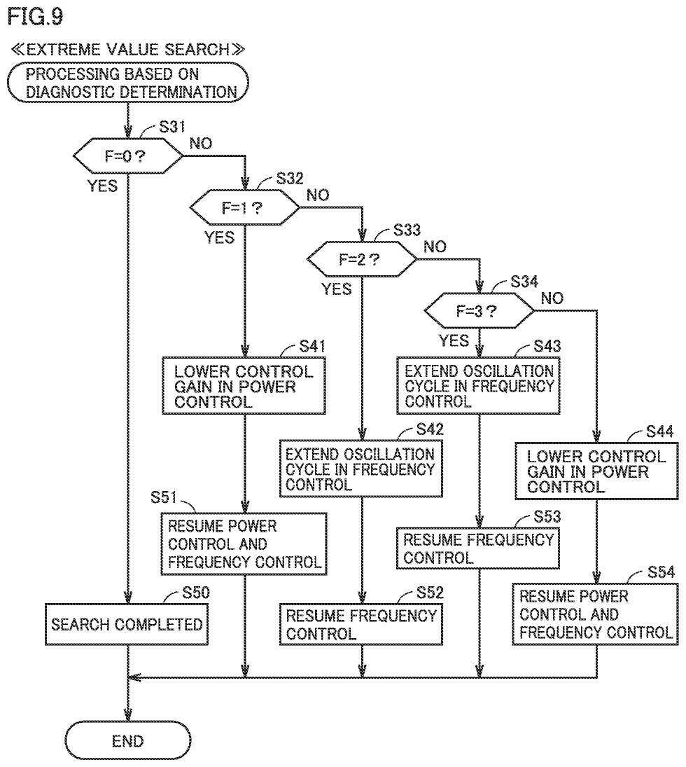

Control circuit 420 generates a duty command value for an output voltage from inverter 220 based on the difference between target power and output power Ps and outputs the generated duty command value to drive signal generator 600. Control circuit 420 calculates an amount of manipulation for bringing the difference closer to 0, for example, by carrying out proportional integral control (PI control) with the difference between target power and output power Ps (output from subtractor 410) being received as an input, and sets the calculated amount of manipulation as duty command value. Feedback control of output power Ps to target power is thus carried out. A control gain in PI control can be varied in accordance with a result of diagnostic determination which will be described later (see FIGS. 8 and 9).

Frequency controller 500 includes a loss detector 510, a high-pass filter (HPF) 520, an oscillation signal generator 530, a multiplier 540, a control circuit 550, and adders 560 and 570.

Loss detector 510 detects power loss in power transmission device 10 (which is also simply referred to as “power loss” below) based on turn-on current It (which is also simply referred to as “It” below), current Is which flows to power transmitter 240 (which is also simply referred to as “Is” below), and output current Iinv from inverter 220 (which is also simply referred to as “Iinv” below). Detected power loss is the sum of power loss due to turn-on current It, power loss due to a current which flows through coil 242, and power loss due to a current which flows through inverter 220. Turn-on current It is expressed by a value (an instantaneous value) detected by current sensor 272 (FIG. 1) at the time when rise of output voltage Vo is sensed by voltage sensor 270 (FIG. 1). Current Is which flows to power transmitter 240 corresponds to a current which flows through coil 242 and is detected by current sensor 274 (FIG. 1). Output current Iinv from inverter 220 corresponds to a current which flows through inverter 220 and is detected by current sensor 272.

Information representing relation among It, Is, Iinv, and power loss (which is referred to as “loss detection information” below) can be used for detecting power loss. Loss detector 510 can find power loss based on It, Is, and Iinv by referring to loss detection information stored in a storage device of power supply ECU 250 in advance. Loss detection information may be expressed by any of a map, a table, an expression, and a model. Loss detection information may be combination of two or more of a map, a table, an expression, and a model.

Loss detector 510 repeatedly detects power loss in prescribed cycles. As power loss is cyclically detected, a waveform Lv1 of power loss is generated. Loss detector 510 outputs generated waveform Lv1 of power loss to HPF 520. A cycle of detection of power loss may be fixed or variable depending on a condition of power reception by power reception device 20.

HPF 520 extracts a high-frequency component Lv2 (for example, a signal obtained by removing a DC component from waveform Lv1 of power loss) from waveform Lv1 of power loss and outputs the extracted component to multiplier 540. HPF 520 is configured to attenuate substantially no high-frequency component higher than a cut-off frequency but to selectively reduce a low-frequency component equal to or lower than the cut-off frequency. With such HPF 520, a component (a high-frequency component) equal to or higher than a prescribed frequency (a cut-off frequency) of waveform Lv1 of power loss can be extracted. HPF 520 according to the embodiment corresponds to one example of the “extractor” according to the present disclosure.

Oscillation signal generator 530 generates an oscillation signal Sv indicating a waveform of a frequency manipulation amount for oscillating an output frequency from inverter 220 (which is referred to as a “first frequency manipulation amount” below) and outputs the oscillation signal to each of multiplier 540 and adder 560. During frequency control, the output frequency from inverter 220 is steadily oscillated by oscillation signal Sv. Though details will be described later, the first frequency manipulation amount represented by oscillation signal Sv is added to a drive frequency f for inverter 220 by adders 560 and 570. The output frequency from inverter 220 is thus oscillated. As a signal (a multiplication value Ms) representing an amount of variation in power loss involved with such oscillation is input to control circuit 550, control circuit 550 can know positional relation between the output frequency from inverter 220 and an optimal frequency and generate a signal for moving the operation frequency from inverter 220 to the optimal frequency.

When an amplitude of oscillation signal Sv is excessively large, output power from inverter 220 may be pulsed due to influence by oscillation of the output frequency from inverter 220. The amplitude of oscillation signal Sv is desirably made smaller to such an extent as achieving suppression of such pulsation. The amplitude of oscillation signal Sv may be fixed or variable depending on a state of output power from inverter 220 (for example, an extent of pulsation). A cycle of oscillation signal Sv (which is also referred to as an “oscillation cycle” below) can be varied in accordance with a result of diagnostic determination which will be described later (see FIGS. 8 and 9). Oscillation signal generator 530 according to the embodiment corresponds to one example of the “first generator” according to the present disclosure.

FIG. 7 is a diagram showing one example of oscillation signal Sv. In FIG. 7, the ordinate represents a first frequency manipulation amount and the abscissa represents time. Referring to FIG. 7, oscillation signal Sv is a continuous pulse signal and repeats a low level (pulse off) and a high level (pulse on) in prescribed oscillation cycles T. For oscillation signal Sv, a frequency manipulation amount (at the low level) during pulse off is denoted as f1 and a frequency manipulation amount (at the high level) during pulse on is denoted as f2. f1 and f2 can be set to any value. One of f1 and f2 may be set to 0. An amplitude Δf of oscillation signal Sv corresponds to a difference (an absolute value) between f1 and f2. Oscillation cycle T corresponds to the sum of a pulse width Ta and a pulse interval Tb. Pulse width Ta and pulse interval Tb may be equal to or different from each other.

Referring again to FIG. 6, multiplier 540 multiplies oscillation signal Sv input from oscillation signal generator 530 by high-frequency component Lv2 input from HPF 520. High-frequency component Lv2 represents an amount of variation in power loss (which is referred to as a “loss variation amount” below) at the time when an output frequency from inverter 220 is oscillated by oscillation signal Sv generated by oscillation signal generator 530. The loss variation amount represented by high-frequency component Lv2 corresponds to a differential coefficient (for example, an inclination of curve k shown in FIG. 5) of power loss.

Multiplier 540 generates multiplication value Ms resulting from multiplication of the loss variation amount represented by high-frequency component Lv2 by the first frequency manipulation amount represented by oscillation signal Sv and outputs the multiplication value to control circuit 550. Multiplication value Ms represents an amount of variation in power loss at the time when drive frequency f for inverter 220 is oscillated.

Control circuit 550 calculates a frequency manipulation amount (which is referred to as a “second frequency manipulation amount” below) for brining multiplication value Ms closer to 0 based on multiplication value Ms input from multiplier 540. Multiplication value Ms being closer to 0 means that an output frequency from inverter 220 is closer to an optimal frequency. The second frequency manipulation amount corresponds to an amount of manipulation for moving the output frequency from inverter 220 to the optimal frequency. Control circuit 550 calculates an amount of manipulation for bringing multiplication value Ms closer to 0, for example, by carrying out integral control (I control) with multiplication value Ms (an output from multiplier 540) being received as an input, and sets the calculated amount of manipulation as the second frequency manipulation amount. Control circuit 550 according to the embodiment corresponds to one example of the “calculator” according to the present disclosure.

Adder 560 adds oscillation signal Sv input from oscillation signal generator 530 to the second frequency manipulation amount input from control circuit 550 and outputs the calculated value to adder 570. Adder 570 obtains drive frequency f for inverter 220 by adding a prescribed reference frequency to a signal input from adder 560 (more specifically, a value resulting from addition of oscillation signal Sv and the second frequency manipulation amount). Then, drive frequency f generated by adder 570 is output to drive signal generator 600. A drive frequency at the time of startup of inverter 220 (which is referred to as a “startup frequency” below) can be adopted as the reference frequency. Though any startup frequency can be set, the startup frequency is preferably set to 81.4 kHz or 90.0 kHz when a frequency band defined under specifications or the like ranges from 81.4 kHz to 90.0 kHz.

Drive signal generator 600 generates a drive signal for inverter 220 (for example, a drive signal for switching elements Q1 to Q4 as shown in FIG. 4) based on duty command value input from power controller 400 and drive frequency f input from frequency controller 500. As inverter 220 is driven by the drive signal generated by drive signal generator 600, a duty of output voltage Vo from inverter 220 attains to a value corresponding to duty command value and an output frequency from inverter 220 attains to a value corresponding to drive frequency f Drive signal generator 600 according to the embodiment corresponds to one example of the “second generator” according to the present disclosure.

In power control, calculation of a difference by subtractor 410, calculation of an amount of manipulation (a duty command value) by control circuit 420, and generation of a drive signal by drive signal generator 600 are repeatedly carried out and inverter 220 is driven by a drive signal generated based on the duty command value calculated by control circuit 420. Magnitude of output power from inverter 220 is thus controlled to converge to target power.

In frequency control, extraction of high-frequency component Lv2 by HPF 520, calculation of multiplication value Ms by multiplier 540, calculation of a second frequency manipulation amount by control circuit 550, and generation of a drive signal by drive signal generator 600 are repeatedly carried out and inverter 220 is driven by a drive signal generated based on the second frequency manipulation amount calculated by control circuit 550. Extreme value search described previously is thus carried out and an output frequency from inverter 220 is controlled to converge to an optimal frequency.

Power supply ECU 250 starts extreme value search, for example, when a request for power transmission is issued. The request for power transmission is issued, for example, when preparation for power transmission is completed. Examples of preparation for power transmission include alignment between power transmission device 10 and power reception device 20. During extreme value search, power transmission device 10 simultaneously carries out power control and frequency control. Output power from inverter 220 driven by a drive signal generated under such control is supplied to power transmitter 240. Wireless power transfer from power transmitter 240 of power transmission device 10 to power receiver 310 of power reception device 20 is thus carried out.

When at least one of magnitude and a frequency of output power from inverter 220 does not converge in power control and frequency control, transmission power becomes unstable. When transmission power becomes unstable, it may excessively become high. Therefore, when a state that transmission power is unstable continues, it may be determined that an abnormal condition has occurred in power transmission device 10 and power transmission to power reception device 20 may be suspended. If a factor which makes transmission power unstable can be identified, however, transmission power can be stabilized by removing the factor so that power transmission can continue.

In power transmission device 10 according to the embodiment, power supply ECU 250 carries out power control and frequency control for a prescribed first period, and when magnitude of output power from inverter 220 does not converge in power control and an output frequency does not converge in frequency control after lapse of the first period, frequency control is stopped. Thereafter, power supply ECU 250 carries out only power control of power control and frequency control for a prescribed second period. When magnitude of output power converges after lapse of the second period, the power supply ECU determines that a condition for frequency control is inappropriate, and when magnitude of output power does not converge after lapse of the second period, the power supply ECU determines that a condition for power control is inappropriate. As a result of this determination, a factor for unstable transmission power (that is, control in which a condition is inappropriate) is identified. In the embodiment, a period from start of extreme value search under power control and frequency control until lapse of a prescribed period of time (a time period corresponding to a length of the first period) corresponds to the first period. A period from stop of frequency control and start of only power control after lapse of the first period until lapse of a prescribed period of time (a time period corresponding to a length of the second period) corresponds to the second period. The first period and the second period can independently be set to any length. The first period and the second period may be equal to or different from each other in length. Determination (more specifically, diagnostic determination) above will be described in detail below with reference to FIG. 8.

FIG. 8 is a flowchart for illustrating diagnostic determination made by power supply ECU 250. The storage device of power supply ECU 250 stores a flag F for diagnosis. Any value from 0 to 4 is set for flag F through processing in FIG. 8. Power supply ECU 250 or a user can know a state of power transmission device 10 based on a value of flag F.

Each of S11 to S19 and S21 to S25 in FIG. 8 represents each step included in the processing in FIG. 8. The processing in FIG. 8 is performed at the timing of lapse of the first period (that is, timing after lapse of a prescribed period of time since start of extreme value search under power control and frequency control).

Referring to FIG. 8, power supply ECU 250 determines whether or not an output frequency from inverter 220 has converged (S11). Convergence can be determined, for example, based on magnitude of an amount of variation during a period from start of processing in S11 until lapse of a prescribed period of time (which is also referred to as a “convergence determination period” below). For example, when an amount of variation in output frequency from inverter 220 during the convergence determination period (for example, a difference between a minimum value and a maximum value during the convergence determination period) is sufficiently small, the output frequency is determined as having converged. A prescribed threshold value found through experiments in advance can be used for determining whether or not an amount of variation is sufficiently small. For example, when an amount of variation is equal to or smaller than a threshold value, the output frequency is determined as having converged, and when an amount of variation exceeds the threshold value, the operation frequency is determined as not having converged. Without being limited as such, various methods are known as a method of determining convergence and any method can be adopted.

When the frequency is determined in S11 as having converged (YES in S11), power supply ECU 250 determines whether or not magnitude of output power from inverter 220 has converged (S12). Convergence can be determined, for example, based on magnitude of an amount of variation as in S11. Various methods are known as a method of determining convergence and any method can be adopted. This is also applicable to S14 and S18 which will be described later.

When magnitude of electric power is determined in S12 as having converged (YES in S12), transmission power is determined as stable and power supply ECU 250 sets flag F to 0 in S21. When magnitude of electric power is determined in S12 as not having converged (NO in S12), power supply ECU 250 stops power control and frequency control in S13. Drive of inverter 220 and hence power transmission from power transmission device 10 to power reception device 20 are thus stopped. Thereafter, power supply ECU 250 sets flag F to 1 in S22. The value for flag F being set to 1 indicates that a condition for power control is inappropriate.

When the frequency is determined in S11 as not having converged (NO in S11), power supply ECU 250 determines whether or not magnitude of output power from inverter 220 has converged (S14). When magnitude of electric power is determined as having converged (YES in S14), power supply ECU 250 stops frequency control in S15. For example, power supply ECU 250 stops operations by oscillation signal generator 530 and control circuit 550 and has the reference frequency (for example, the startup frequency) output to drive signal generator 600 as drive frequency f for inverter 220. Drive frequency f for inverter 220 is thus set to a constant value (reference frequency). Thereafter, power supply ECU 250 sets flag F to 2 in S23. The value for flag F being set to 2 indicates that a condition for frequency control is inappropriate.

When magnitude of electric power is determined in S14 as not having converged (NO in S14), power supply ECU 250 stops frequency control in S16 as in S15. Thereafter, power supply ECU 250 carries out only power control of power control and frequency control for a prescribed period of time (a period of time corresponding to a length of the second period) in S17. After lapse of the second period since start of power control, power supply ECU 250 determines again in S18 whether or not magnitude of output power from inverter 220 has converged.

When magnitude of electric power is determined in S18 as having converged (YES in S18), power supply ECU 250 sets flag F to 3 in S24. A value for flag F being set to 3 indicates that a condition for frequency control is inappropriate.

When magnitude of electric power is determined in S18 as not having converged (NO in S18), power supply ECU 250 stops power control in S19 by stopping operations by power controller 400. Drive of inverter 220 and hence power transmission from power transmission device 10 to power reception device 20 are thus stopped. Thereafter, power supply ECU 250 sets flag F to 4 in S25. The value for flag F being set to 4 indicates that a condition for power control is inappropriate.

Processing performed by power supply ECU 250 after diagnostic determination above will now be described with reference to FIG. 9. FIG. 9 is a flowchart for illustrating processing based on a result of diagnostic determination in FIG. 8.

Each of S31 to S34, S41 to S44, and S50 to S54 in FIG. 9 represents each step included in processing in FIG. 9. Processing in FIG. 9 is performed after the processing in FIG. 8 ends.

Referring to FIG. 9, in S31 to S34, to which of 0 to 4 a value for flag F has been set in the processing in FIG. 8 is determined. Since a value which can be taken by flag F is any of 0, 1, 2, 3, and 4, none of 0, 1, 2, and 3 being set as a value for flag F means that a value for flag F is set to 4.

When a value for flag F is set to 0 (YES in S31), it is determined that extreme value search by power supply ECU 250 has normally been completed (S50). The value for flag F being set to 0 means that magnitude and a frequency of output power from inverter 220 both have converged (that is, transmission power is stable) (see FIG. 8).

When the value for flag F has been set to 1 (NO in S31 and YES in S32), power supply ECU 250 decreases a control gain (for example, a proportional gain in PI control by control circuit 420) in power control (S41). After power supply ECU 250 changed a condition for power control (control gain) in S41, it resumes power control and frequency control (S51). Drive of inverter 220 and hence power transmission from power transmission device 10 to power reception device 20 are thus started. Extreme value search is also started. The value for flag F being set to 1 means that a frequency of electric power has converged in frequency control whereas magnitude of electric power has not converged in power control when power control and frequency control are carried out for the first period (see FIG. 8).

When the value for flag F is set to 2 (NO in S31 and S32 and YES in S33), power supply ECU 250 extends oscillation cycle T of oscillation signal Sv (FIG. 7) generated by oscillation signal generator 530 (S42). Power supply ECU 250 extends oscillation cycle T, for example, by extending both of pulse width Ta and pulse interval Tb. Without being limited as such, oscillation cycle T may be extended by extending only one of pulse width Ta and pulse interval Tb. After power supply ECU 250 changed a condition for frequency control (oscillation cycle T) in S42, it again starts up oscillation signal generator 530 and control circuit 550 and resumes frequency control (S52). Both of power control and frequency control are thus carried out and extreme value search is started. The value for flag F being set to 2 means that magnitude of electric power has converged in power control whereas a frequency of electric power has not converged in frequency control when power control and frequency control are carried out for the first period (see FIG. 8).

When the value for flag F is set to 3 (NO in S31 to S33 and YES in S34), power supply ECU 250 performs S43 and S53 as in S42 and S52. Specifically, oscillation cycle T of oscillation signal Sv is extended in S43 and frequency control is resumed in S53. Then, extreme value search is started. An extent of extension of oscillation cycle T (how long oscillation cycle T should be extended) may be the same or different between S42 and S43. The value for flag F being set to 3 means that magnitude of electric power has converged by stopping frequency control while neither of magnitude and a frequency of output power from inverter 220 has converged (see FIG. 8).

When the value for flag F is set to 4 (NO in all of S31 to S34), power supply ECU 250 performs S44 and S54 as in S41 and S51. Specifically, a control gain (for example, a proportional gain) in power control is lowered in S44 and power control and frequency control are resumed in S54. Then, extreme value search is started. An extent of lowering in control gain (how much a control gain should be lowered) may be the same or different between S41 and S44. The value for flag F being set to 4 means that magnitude of electric power has not converged even by stopping frequency control while neither of magnitude and a frequency of output power from inverter 220 has converged (see FIG. 8).

Extreme value search is started by processing in S51 to S54 in FIG. 9. After lapse of the first period since start of extreme value search, processing in FIG. 8 is started again. Basically, processing in FIG. 8 and processing in FIG. 9 are repeatedly performed until extreme value search is determined as having normally been completed in S50 in FIG. 9. When transmission power is unstable, a factor therefor is identified by processing in FIG. 8, and processing for removing the factor (more specifically, change in control condition) is performed by the processing in FIG. 9. Power transmission can thus continue with transmission power being stabilized.

Transmission power may become unstable also due to some kind of an abnormal condition in the power transfer system. Therefore, when a prescribed suspension condition is satisfied, loop processing above may exit (repeated processing of processing in FIG. 8 and processing in FIG. 9) and power transmission may be suspended. For example, a suspension condition may be satisfied when the number of times of change in control condition in the processing in FIG. 9 (S41 to S44) exceeds a prescribed number of times. The prescribed number of times is defined as a threshold value for sensing an abnormal condition, and for example, an upper limit value which can be taken under a normal condition may be set. When the suspension condition is satisfied, a user may be notified of the abnormal condition.

In the embodiment, values different between S22 and S25 (1 and 4) in FIG. 8 are set for flag F such that an amount of lowering in control gain in power control can be varied (for example, an amount of lowering in gain in S44 is made larger than in S41) between processing performed at the time when determination as NO is made in S12 in FIG. 8 (S41 in FIG. 9) and processing performed at the time when determination as NO is made in S18 in FIG. 8 (S44 in FIG. 9). Without being limited as such, when identical processing is performed in S41 and S44, a value identical in S22 and S25 in FIG. 8 may be set for flag F.

In the embodiment, values different between S23 and S24 (2 and 3) in FIG. 8 are set for flag F such that extension of oscillation cycle T in frequency control can be varied (for example, extension of oscillation cycle T in S43 is more than in S42) between processing performed at the time when determination as YES is made in S14 in FIG. 8 (S42 in FIG. 9) and processing performed at the time when determination as YES is made in S18 in FIG. 8 (S43 in FIG. 9). Without being limited as such, when identical processing is performed in S42 and S43, a value identical in S23 and S24 in FIG. 8 may be set for flag F.

In the embodiment, after a factor for unstable transmission power is identified in processing in FIG. 8, processing for removing the factor (processing in FIG. 9) is automatically performed. Without being limited as such, power supply ECU 250 may perform processing up until setting of flag F (processing in FIG. 8) and processing thereafter may be left to a user.

A configuration for carrying out power control and frequency control in a wireless power transmission device is not limited to the configuration shown in FIG. 6 but can be modified as appropriate. For example, a low-pass filter may be provided between multiplier 540 and control circuit 550. Control circuit 550 may carry out PI control instead of I control.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A wireless power transmission device comprising:
a power transmitter configured to wirelessly transmit power to a power reception device;
an inverter configured to generate power at a prescribed frequency and output the generated power to the power transmitter;
a loss detector configured to detect power loss; and
a controller configured to control output power from the inverter,
the controller being configured to carry out
power control for converging magnitude of the output power to target power, and
frequency control for converging a frequency of the output power to an optimal frequency at which power loss detected by the loss detector is minimized,
the controller being configured to
stop the frequency control and perform only the power control for a prescribed second period when magnitude of the output power does not converge and a frequency of the output power does not converge in the power control and the frequency control carried out for a prescribed first period,
determine that a condition for the frequency control is inappropriate when magnitude of the output power has converged after lapse of the second period, and
determine that a condition for the power control is inappropriate when magnitude of the output power does not converge after lapse of the second period.

2. The wireless power transmission device according to claim 1, wherein
the controller is configured, in the power control and the frequency control carried out for the first period, to
determine that the condition for the frequency control is inappropriate when magnitude of the output power has converged in the power control and the frequency of the output power does not converge in the frequency control, and
determine that the condition for the power control is inappropriate when the frequency of the output power has converged in the frequency control and magnitude of the output power does not converge in the power control.

3. The wireless power transmission device according to claim 1, wherein
when the condition for the power control is determined as inappropriate, the controller is configured to decrease a control gain in the power control.

4. The wireless power transmission device according to claim 1, wherein
the controller includes
a first generator configured to generate an oscillation signal indicating a waveform of a first frequency manipulation amount for oscillating a frequency of the output power,
an extractor configured to extract a high-frequency component from a waveform of power loss cyclically detected by the loss detector,
a multiplier configured to obtain a multiplication value resulting from multiplication of a loss variation amount by the first frequency manipulation amount, the loss variation amount being represented by the high-frequency component, the first frequency manipulation amount being represented by the oscillation signal,
a calculator configured to calculate a second frequency manipulation amount for bringing the multiplication value closer to 0, and
a second generator configured to generate a drive signal for the inverter by using a prescribed reference frequency, the second frequency manipulation amount, and the oscillation signal.

5. The wireless power transmission device according to claim 4, wherein
when the condition for the frequency control is determined as inappropriate, the controller is configured to extend an oscillation cycle of the oscillation signal.

6. The wireless power transmission device according to claim 1, wherein
the power transmitter includes a resonant circuit including a power transmission coil,
the inverter includes a switching element driven by a drive signal from the controller and a freewheel diode connected in parallel to the switching element, and
the loss detector is configured to detect the power loss by using a current flowing through the power transmission coil, a current flowing through the inverter, and a turn-on current representing an output current from the inverter at rise of an output voltage from the inverter.

7. A power transfer system comprising:
a power transmission device; and
a power reception device configured to wirelessly receive power from the power transmission device,
the power transmission device including
a power transmitter configured to wirelessly transmit power to the power reception device,
an inverter configured to generate power at a prescribed frequency and output the generated power to the power transmitter,
a loss detector configured to detect power loss, and
a controller configured to control output power from the inverter,
the controller being configured to carry out
power control for converging magnitude of the output power to target power, and
frequency control for converging a frequency of the output power to an optimal frequency at which power loss detected by the loss detector is minimized,
the controller being configured to
stop the frequency control and perform only the power control for a prescribed second period when magnitude of the output power does not converge and a frequency of the output power does not converge in the power control and the frequency control carried out for a prescribed first period,
determine that a condition for the frequency control is inappropriate when magnitude of the output power has converged after lapse of the second period, and
determine that a condition for the power control is inappropriate when magnitude of the output power does not converge after lapse of the second period.
